(19) United States
(12) Patent Application Publication
(10) Pub. No.: US 2018/0241841 A1
(43) Pub. Date: Aug. 23, 2018

(54) INFORMATION SYSTEM

(71) Applicants: Taro OKUYAMA, Tokyo (JP); Akihiro MIHARA, Tokyo (JP)

(72) Inventors: Taro OKUYAMA, Tokyo (JP); Akihiro MIHARA, Tokyo (JP)

(21) Appl. No.: 15/958,055

(22) Filed: Apr. 20, 2018

Related U.S. Application Data
(63) Continuation of application No. PCT/JP2016/004665, filed on Oct. 24, 2016.

(30) Foreign Application Priority Data
Oct. 26, 2015 (JP) 2015-209548
Mar. 18, 2016 (JP) 2016-056126

(51) Int. Cl. H04L 29/08; G06F 8/71

(52) U.S. Cl. CPC H04L 67/32; H04L 67/303; G06F 8/61; G06F 8/71; H04L 67/141

(57) ABSTRACT

An information system includes a server and a client that is connected to the server. The server transmits, when receiving a connection request from the client, a response that includes any one of version information of software in the server and version information of a communication protocol in the server, to the client. The client determines whether a communication protocol in the client is compatible with the server based on the response from the server.

### CROSS-REFERENCE TO RELATED APPLICATIONS

This application is a continuation of PCT international Application Ser. No. PCT/JP2016/004665, filed on Oct. 24, 2016, which designates the United States and which claims the benefit of priority from Japanese Patent Applications No. 2015-209548, filed on Oct. 26, 2015 and No. 2016-056126, filed on Mar. 18, 2016; the entire contents of which are incorporated herein by reference.

### BACKGROUND OF THE INVENTION

### 1. Field of the Invention

The present invention relates to an information system.

### 2. Description of the Related Art

An information system in which a client is connected to a server through a network, and communicates information has been used in various fields.

In Japanese Unexamined Patent Application Publication No. 2013-105187, a relay communication system that has multiple relay servers connected to a network so as to enable communication, and a center server that manages the communication among the relay servers connected to the network is disclosed. Each of the relay servers has a version determining unit that compares a version of software that is to be installed thereinto and a version of software held in the center server, and inhibits installation of the software to be installed to each of the relay servers when the software to be installed to each of the relay servers has no compatibility with the software of the center server, and permits installation of the software to each of the relay servers in the opposite case.

Moreover, Japanese Unexamined Patent Application Publication No. 2005-196269, a terminal device that has a terminal communication unit that is capable of wireless communication with a server device, a terminal storage unit to store a predetermined terminal program that can be downloaded from the server device through the terminal communication unit, and a terminal control unit that can execute the predetermined terminal program stored in the terminal storage unit, and that creates request data for the server device is disclosed. This terminal device is a rich client terminal device configured to be able to perform data communication with the server device by the terminal communication unit for a processing result of executing the terminal program by the terminal control unit, and the terminal control unit creates request data such that by transmitting the request data to the server device through the terminal communication unit from the terminal device, the server device accesses a database connected thereto as necessary, and returns response data corresponding to the request data.

In information systems constituted of a server and a client, respective communication protocols require to have compatibility with each other. For example, there is a possibility that although it has not been assumed that a communication protocol cannot maintain compatibility at the time of release of the first edition of software, such an upgrade that the compatibility cannot be maintained occurs later, to require a compatibility determining function.

That is, it can cause a state that servers of an old version have no compatibility determining function, while servers of a new version have a compatibility determining function. In such a condition, there has been an inconvenience that the compatibility in communication cannot be determined when a client is connected to a server of an old version having no compatibility determining function.

### SUMMARY OF THE INVENTION

According to one aspect of the invention, an information system includes a server and a client that is connected to the server. The server transmits, when receiving a connection request from the client, a response that includes any one of version information of software in the server and version information of a communication protocol in the server, to the client. The client determines whether a communication protocol in the client is compatible with the server based on the response from the server.

### BRIEF DESCRIPTION OF THE DRAWINGS

FIG. 1 is a diagram for explaining an outline of an information system according to one embodiment of the present invention;

FIG. 2 is a diagram for explaining a hardware configuration of an electronic whiteboard;

FIG. 3 is a block diagram for explaining a function of an electronic whiteboard A;

FIG. 4 is a block diagram for explaining a function of an electronic whiteboard B;

FIG. 5 is a diagram for explaining a hardware configuration of a terminal;

FIG. 6 is a block diagram for explaining a function of the terminal;

FIG. 7 is a diagram for explaining relation between a software version and a communication protocol version in the electronic whiteboard;

FIG. 8 is a diagram for explaining relation between a software version and a communication protocol version in the terminal;

FIG. 9 is a diagram for explaining compatibility of a communication protocol;

FIG. 10 is a diagram for explaining a login screen;

FIG. 11 is a diagram for explaining Example 1;

FIG. 12 is a diagram for explaining a version-communication protocol correspondence table;

FIG. 13 is a diagram for explaining Example 2;

FIG. 14 is a diagram for explaining an error dialogue;

FIG. 15 is a diagram for explaining Example 3;

FIG. 16 is a diagram for explaining Example 4;

FIG. 17 is a diagram for explaining Example 5;

FIG. 18 is a diagram for explaining a management server;

FIG. 19 is a diagram for explaining Example 6; and

FIG. 20 is a diagram for explaining Example 7.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

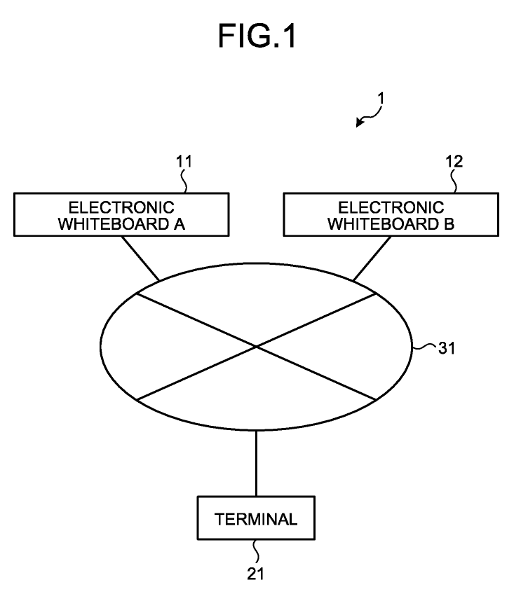

An embodiment of the present invention is explained below. FIG. 1 depicts a schematic configuration of an information system 1 according to one embodiment.

The information system 1 includes a network 31, an electronic whiteboard A 11, an electronic whiteboard B 12, a terminal 21, and the like. In this example, the electronic whiteboard A 11 and the electronic whiteboard B 12 are servers, and the terminal 21 is a client.

As the terminal 21, a laptop personal computer (PC) or a tablet PC can be used.

As the network 31, various kinds of communication networks, regardless of wired or wireless communication, such as a local area network (LAN) and the Internet can be used.

A hardware configuration of each electronic whiteboard is explained. The electronic whiteboard A 11 and the electronic whiteboard B 12 have the same hardware configuration.

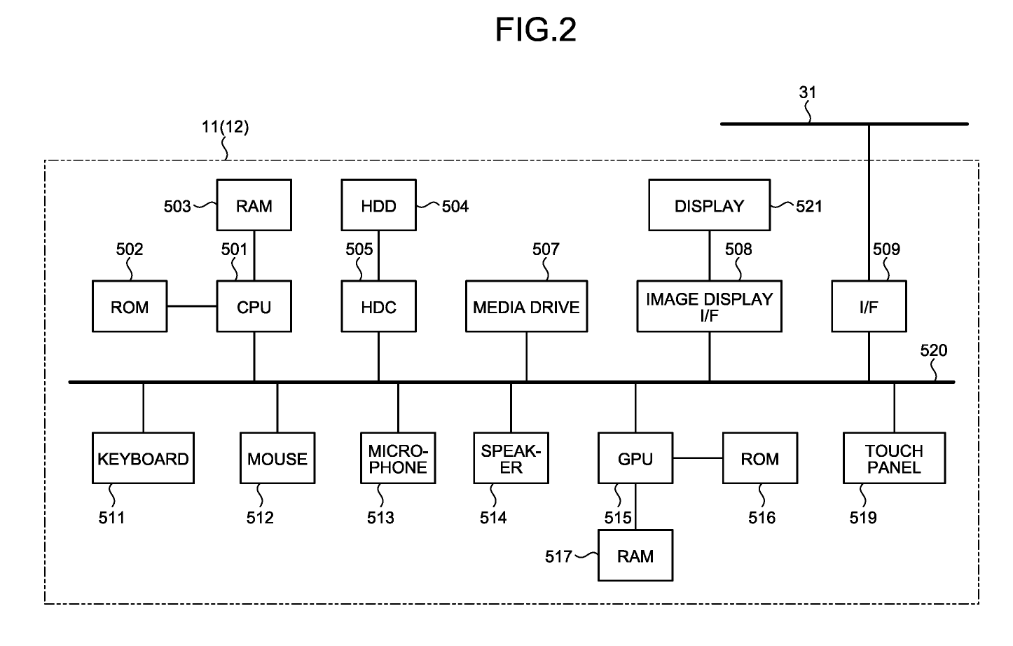

Each of the electronic whiteboards includes, as shown in FIG. 2 as one example, a central processing unit (CPU) 501, a read-only memory (ROM) 502, a random access memory (RAM) 503, a hard disc drive (HDD) (504), a hard disk controller (HDC) 505, a media drive 507, an image display interface (I/F) 508, an interface (I/F) 509, a keyboard 511, a mouse 512, a microphone 513, a speaker 514, a graphics processing unit (GPU) 515, a ROM 516, a RAM 517, a touch panel 519, and a display 521.

The CPU 501, the HDC 505, the media drive 507, the image display interface 508, the interface 509, the keyboard 511, the mouse 512, the microphone 513, the speaker 514, the GPU 515, and the touch panel 519 are electrically connected to each other through a bus 520.

The CPU 501 controls operation of the entire electronic whiteboard. The ROM 502 is a memory that stores multiple programs executed by the CPU 501 and multiple pieces of data. The RAM 503 is a work memory of the CPU 501.

In the HDD 504, various kinds of programs and various kinds of data are stored. The HDC 505 controls read and write from and to the HDD 504. The media drive 507 controls read and write of data from and to a recording medium such as a flash memory.

The image display interface 508 is an interface to which the display 521 is connected. The interface 509 is an interface to which the network 31 is connected.

The GPU 515 performs processing relating to graphics. The ROM 516 is a memory that stores various kinds of programs executed by the GPU 515. The RAM 517 is a work memory of the GPU 515.

The bus 520 is a bus that includes an address bus and a data bus. Moreover, the touch panel 519 is integrated with the display 521, and detects coordinates of a position of contact of an input pen or a finger on the display 521.

Next, a function of each electronic whiteboard is explained. The function of each of the electronic whiteboards is implemented by the hardware, the programs, and the various kinds of data described above.

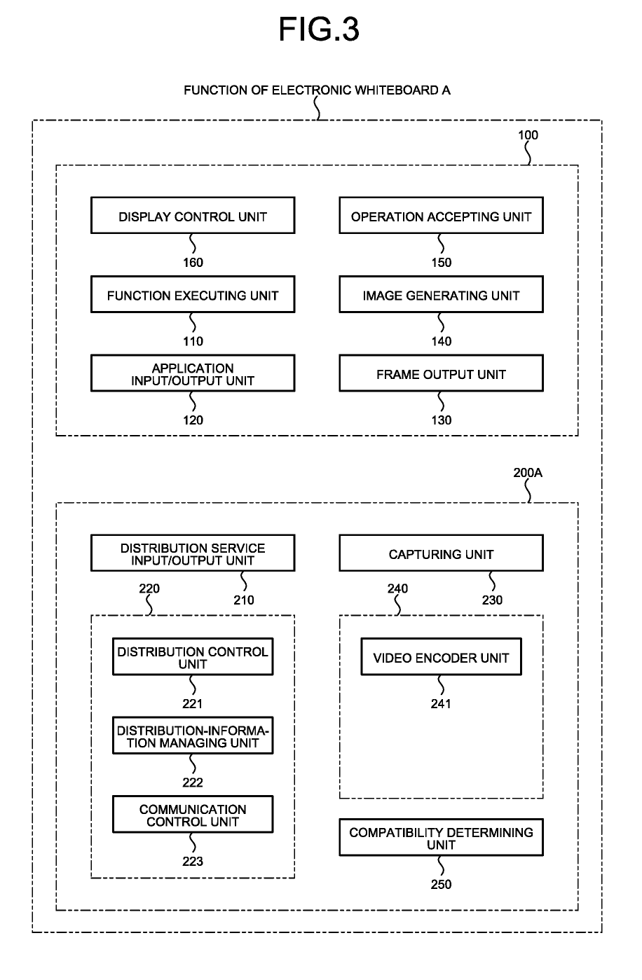

The function of the electronic whiteboard A 11 can be roughly divided into a whiteboard application 100 and a video distribution service 200A as shown in FIG. 3.

The whiteboard application 100 includes a function executing unit 110, an application input/output unit 120, a frame output unit 130, an image generating unit 140, an operation accepting unit 150, a display control unit 160, and the like.

The function executing unit 110 executes a function specific to the electronic whiteboard. Furthermore, the function executing unit 110 converts received data into data in a format that can be processed. Moreover, the function executing unit 110 informs a distribution service input/output unit 210 of start and stop of services.

The application input/output unit 120 informs, when receiving output information of the distribution service input/output unit 210, for example, an operation event, the function executing unit 110 thereof.

The frame output unit 130 outputs an image to be distributed to the terminal 21 as a video. For example, an image of RGB bitmap data is output as a video compressed by H.264/AVC format.

The image generating unit 140 generates a display image by superimposing an operation panel image and a whiteboard image, to output to the display control unit 160. Furthermore, the image generating unit 140 generates a distribution image that is formed with a whiteboard image, to output to the frame output unit 130.

The operation panel image includes multiple function icons, and for example, when the operation accepting unit 150 detects that a pen icon is selected by an input pen, the function executing unit 110 changes the color used at writing.

The operation accepting unit 150 accepts an operation such as writing based on coordinates of an input pen or a finger that is detected by the touch panel 519.

The display control unit 160 displays the display image generated by the image generating unit 140 on the display 521.

The frame output unit 130 outputs the distribution image that is generated by the image generating unit 140 to the video distribution service 200A.

The video distribution service 200A includes, as shown in FIG. 3, the distribution service input/output unit 210, a distribution module 220, a capturing unit 230, a codec module 240, a compatibility determining unit 250, and the like.

The distribution service input/output unit 210 receives output information of the application input/output unit 120, for example, start and stop of services. Moreover, the distribution service input/output unit 210 transmits information from the terminal 21, such as an operation event, to the application input/output unit 120.

The capturing unit 230 acquires a distribution image to be output to the frame output unit 130, and sends it to the codec module 240.

The codec module 240 includes a video encoder unit 241. The video encoder unit 241 generates a video stream (compressed distribution video) by compressing the distribution image from the capturing unit 230, and sends it to the distribution module 220.

The distribution module 220 includes a distribution control unit 221, a distribution-information managing unit 222, and a communication control unit 223, and transmits the compressed distribution video to the terminal 21.

The distribution-information managing unit 222 manages video encoding setting relating to distribution, and information about the terminal 21 being connected. The communication control unit 223 functions as a communication means, and performs control of an entire distribution function, an activation instruction and an end instruction of the codec module 240.

The compatibility determining unit 250 determines compatibility between a communication protocol of the communication control unit 223 and a communication protocol of the terminal 21.

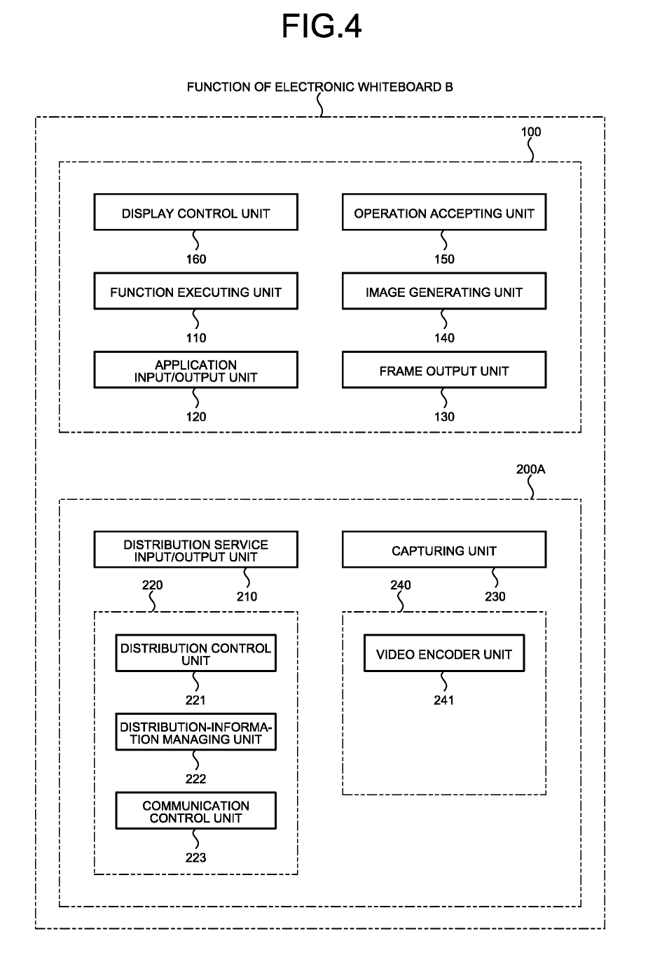

The function of the electronic whiteboard B 12 can be roughly divided into the whiteboard application 100 and a video distribution service 200B as shown in FIG. 4.

The video distribution service 200B is the video distribution service 200A described above excluding the compatibility determining unit 250 therefrom. That is, the difference between the electronic whiteboard A 11 and the electronic whiteboard B 12 is only whether the compatibility determining unit 250 is included.

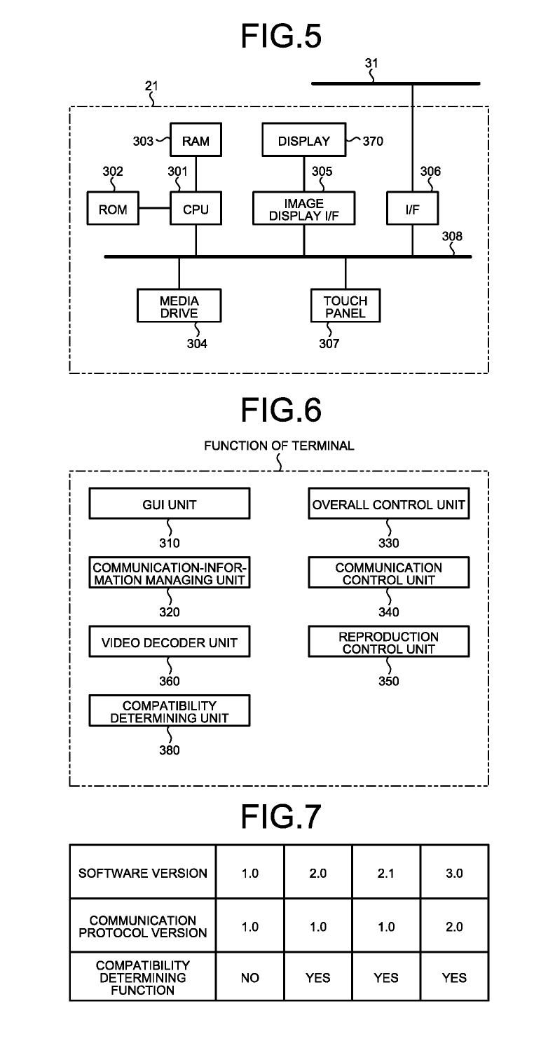

A hardware configuration of the terminal 21 is explained. The terminal 21 includes, as shown in FIG. 5 as one example, a CPU 301, a ROM 302, a RAM 303, a media drive 304, an image display interface (I/F) 305, an interface (I/F) 306, a touch panel 307, a bus 308, and a display 370.

The CPU 301 controls operation of the entire terminal 21. The ROM 302 is a memory that stores multiple programs executed by the CPU 301 and multiple pieces of data. The RAM 303 is a work memory of the CPU 301.

The image display interface 305 is an interface to which the display 370 is connected. The interface 306 is an interface to which the network 31 is connected.

The bus 308 is a bus including an address bus and a data bus. Moreover, the touch panel 307 is integrated with the display 370, and detects coordinates of a position of contact of an input pen or a finger on the display 370.

Next, a function of the terminal 21 is explained. The function of the terminal 21 is implemented by the hardware, the programs, and the various kinds of data described above.

The function of the terminal 21 includes, as shown in FIG. 6, a GUI unit 310, a communication-information managing unit 320, an overall control unit 330, a communication control unit 340, a reproduction control unit 350, a video decoder unit 360, the display 370, a compatibility determining unit 380, and the like.

The GUI unit 310 displays a user interface (UI) image on the display 370 of the terminal 21. The overall control unit 330 performs overall control, such as start of communication and disconnection of communication.

The communication-information managing unit 320 holds information relating to distribution, for example, video encoding setting. The communication control unit 340 controls communication with each of the electronic whiteboards.

The reproduction control unit 350 transmits a compressed video from the electronic whiteboard to the video decoder unit 360. The video decoder unit 360 decodes the compressed video to display on the display 370. The display 370 includes a liquid crystal panel, and displays a GUI based on an image signal from the GUI unit 310, and displays a distribution image based on an image signal from the video decoder unit 360.

The compatibility determining unit 380 determines compatibility between a communication protocol of the communication control unit 340 and a communication protocol of the electronic whiteboard.

Suppose that software for the electronic whiteboard has been upgraded, as shown in FIG. 7 as one example, as version 1.0, version 2.0, version 2.1, to version 3.0. In addition, suppose that the communication protocol has been upgraded from version 1.0 to version 2.0 in software of version 3.0. Moreover, suppose that a compatibility determining function of a communication protocol of software is added to version 2.0 and later.

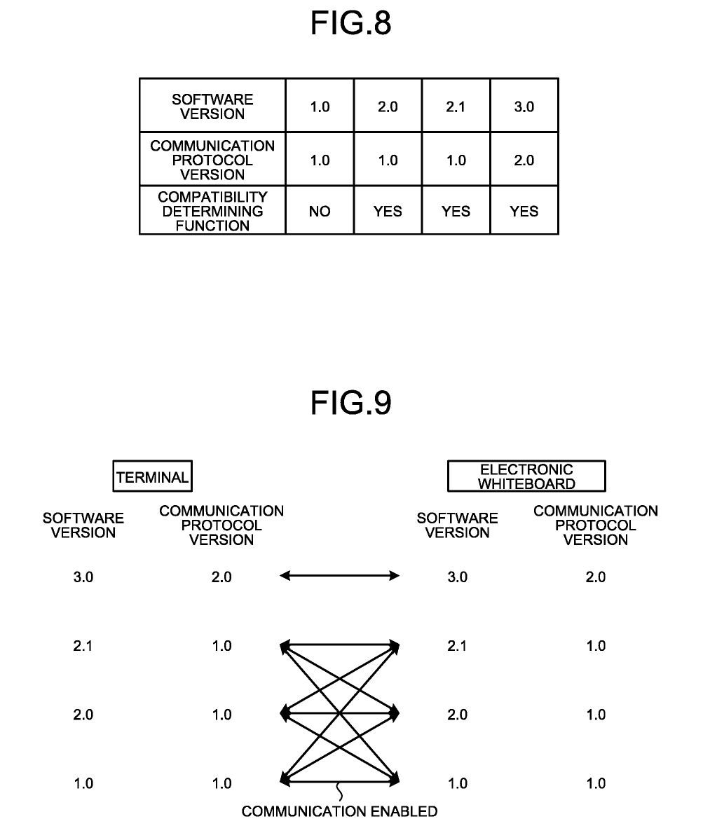

Suppose that software for the terminal has been upgraded, as shown in FIG. 8 as one example, as version 1.0, version 2.0, version 2.1, to version 3.0. In addition, suppose that the communication protocol has been upgraded from version 1.0 to version 2.0 in software of version 3.0. Moreover, suppose that a compatibility determining function of a communication protocol of software is added to version 2.0 and later.

The electronic whiteboard and the terminal can communicate with each other only when the versions of the respective communication protocols are identical to each other (refer to FIG. 9).

For example, a terminal having software, the version of which is 1.0 can communication with an electronic whiteboard having software, the version of which is 1.0, 2.0, or 2.1, but not with an electronic whiteboard having software, the version of which is 3.0. On the other hand, a terminal having software, the version of which is 3.0 can communicate with an electronic whiteboard having software, the version of which is 3.0, but not with an electronic whiteboard having software, the version of which is 1.0, 2.0, or 2.1.

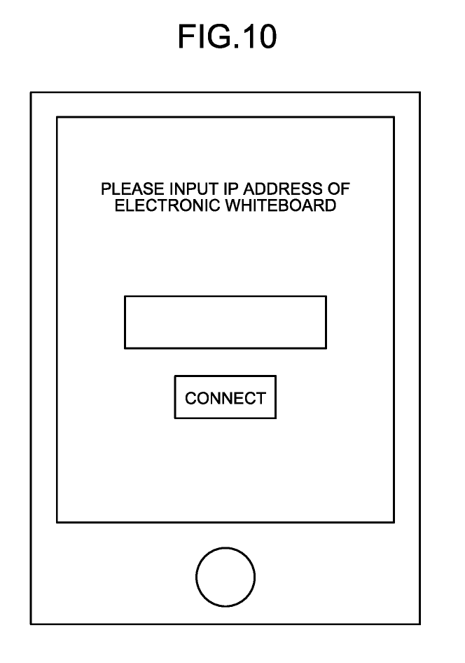

Next, a case in which a user of the terminal 21 connects to an electronic whiteboard is explained. Suppose that on the display 370 of the terminal 21, a login screen as shown in FIG. 10 as one example is displayed.

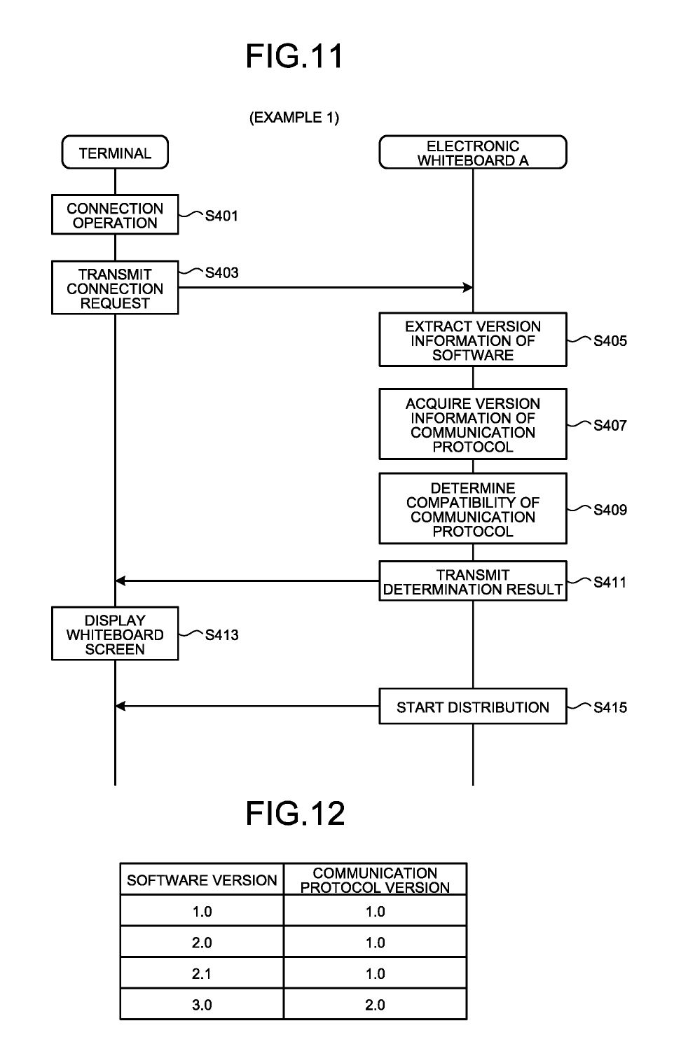

Example 1 is explained using FIG. 11.

In this Example 1, the version of software in the terminal 21 is 2.0, and a connection destination of the terminal 21 is the electronic whiteboard A 11. The version of software in the electronic whiteboard A 11 is 2.0.

When a user of the terminal 21 inputs an IP address of the electronic whiteboard A 11 in the login screen, and presses a “connect” button (step S401), the communication control unit 340 transmits a connection request including version information of software in the terminal 21 (step S403). In addition to the IP address of the electronic whiteboard A 11, authentication information such as a password can be input.

In the electronic whiteboard A 11, when receiving the connection request, the communication control unit 223 extracts the version information of software in the terminal 21 that is included in the connection request (step S405), and sends the information to the compatibility determining unit 250.

The compatibility determining unit 250 acquires version information of a communication protocol in the terminal 21 from the version information of software in the terminal 21 (step S407). Herein, as one example, the electronic whiteboard A 11 has a version-communication protocol correspondence table as shown in FIG. 12, and the compatibility determining unit 250 refers to the version-communication protocol correspondence table, and acquires version information of the communication protocol in the terminal 21 from the version information of software in the terminal 21.

The compatibility determining unit 250 then determines compatibility between the communication protocol in the communication terminal 21 and the communication protocol in the communication control unit 223 (step S409). In this example, as the version of the communication protocol in the terminal 21 is 1.0, and the version of the communication protocol in the communication control unit 223 is 1.0, it is determined as “compatible”.

The electronic whiteboard A 11 transmits the determination result to the terminal 21 through the communication control unit 223 (step S411). The determination result can be displayed on the display 521 of the electronic whiteboard A 11.

Receiving the determination result as “compatible”, the terminal 21 displays a whiteboard screen on the display 370 through the GUI unit 310 (step S413).

The electronic whiteboard A 11 starts video distribution to the terminal 21 (step S415). Thus, the electronic whiteboard A 11 and the terminal 21 start to share a screen.

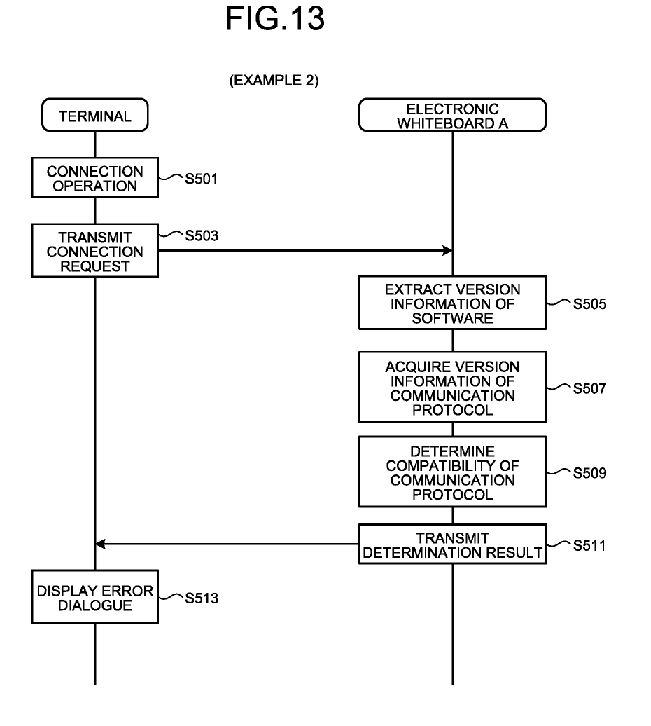

Example 2 is explained using FIG. 13.

In this Example 2, the version of software in the terminal 21 is 2.0, and a connection destination of the terminal 21 is the electronic whiteboard A 11. The version of software in the electronic whiteboard A 11 is 3.0.

When a user of the terminal 21 inputs an IP address of the electronic whiteboard A 11 in the login screen, and presses a “connect” button (step S501), the communication control unit 340 transmits a connection request including version information of software in the terminal 21 (step S503). In addition to the IP address of the electronic whiteboard A 11, authentication information such as a password can be input.

In the electronic whiteboard A 11, when receiving the connection request, the communication control unit 223 extracts the version information of software in the terminal 21 that is included in the connection request (step S505), and sends the information to the compatibility determining unit 250.

The compatibility determining unit 250 acquires version information of a communication protocol in the terminal 21 from the version information of software in the terminal 21 (step S507). In this example, similarly to Example 1 above, referring to the version-communication protocol correspondence table, version information of the communication protocol in the terminal 21 is acquired from the version information of software in the terminal 21.

The compatibility determining unit 250 then determines compatibility between the communication protocol in the communication terminal 21 and the communication protocol in the communication control unit 223 (step S509). In this example, as the version of the communication protocol in the terminal 21 is 1.0, and the version of the communication protocol in the communication control unit 223 is 2.0, it is determined as “incompatible”.

The electronic whiteboard A 11 transmits the determination result to the terminal 21 through the communication control unit 223 (step S511). The determination result can be displayed on the display 521 of the electronic whiteboard A 11.

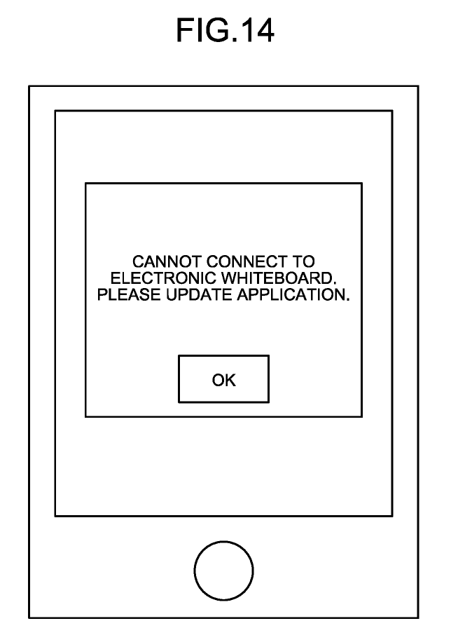

Receiving the determination result as “incompatible”, the terminal 21 displays an error dialogue (refer to FIG. 14) on the display 370 through the GUI unit 310 (step S513). In addition to a message that connection cannot be established, a message indicating whether a version of software on the terminal is old, or a version of software on the electronic whiteboard is old can be displayed.

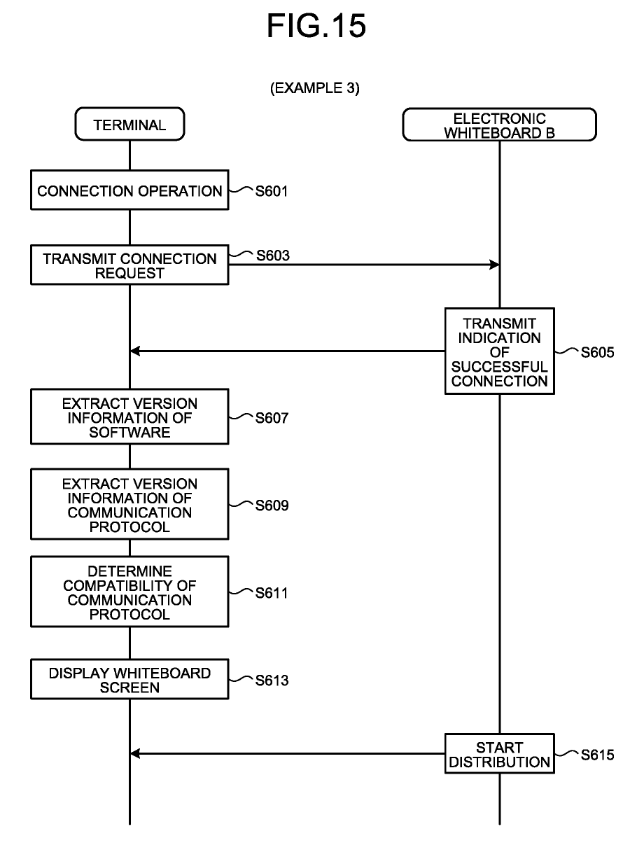

Example 3 is explained using FIG. 15.

In this Example 3, the version of software in the terminal 21 is 2.0, and a connection destination of the terminal 21 is the electronic whiteboard B 12. The version of software in the electronic whiteboard B 12 is 1.0.

When a user of the terminal 21 inputs an IP address of the electronic whiteboard B 12 in the login screen, and presses a “connect” button (step S601), the communication control unit 340 transmits a connection request including version information of software in the terminal 21 (step S603). In addition to the IP address of the electronic whiteboard B 12, authentication information such as a password can be input.

In the electronic whiteboard B 12, when receiving the connection request, the communication control unit 223 transmits, as a response thereto, an indication of successful connection including the version information of software in the electronic whiteboard B 12 to the terminal 21 (step S605).

In the terminal 21, when receiving the indication of successful connection, the communication control unit 340 extracts the version information of software in the electronic whiteboard B 12 that is included in the indication of successful connection (step S607), and sends the information to the compatibility determining unit 380.

The compatibility determining unit 380 acquires version information of a communication protocol in the electronic whiteboard B 12 from the version information of software in the electronic whiteboard B 12 (step S609). Herein, as one example, the terminal 21 has a version-communication protocol correspondence table similarly to the one shown in FIG. 12, and the compatibility determining unit 380 refers to the version-communication protocol correspondence table, and acquires version information of the communication protocol in the electronic whiteboard B 12 from the version information of software in the electronic whiteboard B 12.

The compatibility determining unit 380 then determines compatibility between the communication protocol in the electronic whiteboard B 12 and the communication protocol in the communication control unit 340 (step S611). In this example, as the version of the communication protocol in the electronic whiteboard B 12 is 1.0, and the version of the communication protocol in the communication control unit 340 is 1.0, it is determined as “compatible”.

The terminal 21 displays a whiteboard screen on the display 370 through the GUI unit 310 (step S613).

The electronic whiteboard B 12 starts video distribution to the terminal 21 (step S615). Thus, the electronic whiteboard B 12 and the terminal 21 start to share a screen.

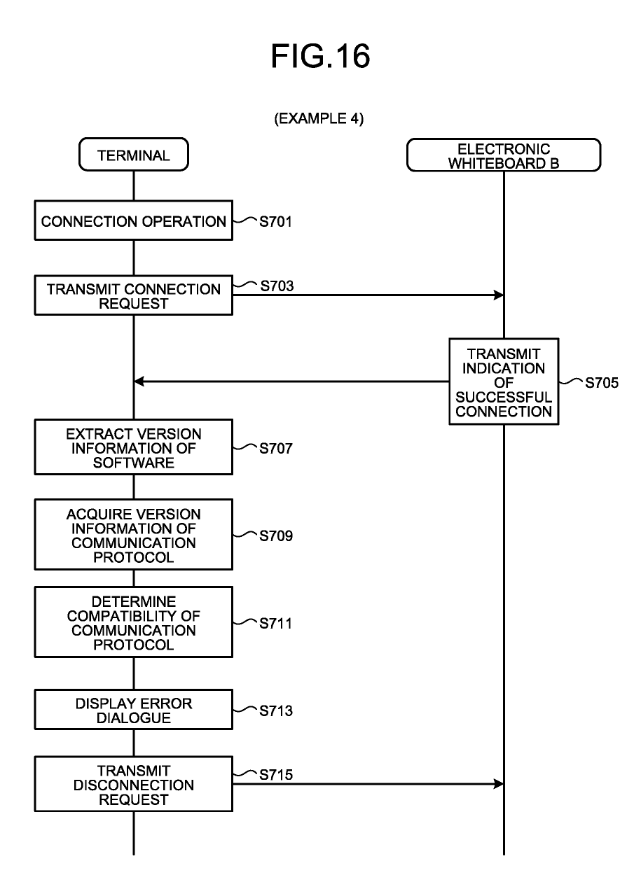

Example 4 is explained using FIG. 16.

In this Example 4, the version of software in the terminal 21 is 3.0, and a connection destination of the terminal 21 is the electronic whiteboard B 12. The version of software in the electronic whiteboard B 12 is 1.0.

When a user of the terminal 21 inputs an IP address of the electronic whiteboard B 12 in the login screen, and presses a “connect” button (step S701), the communication control unit 340 transmits a connection request including version information of software in the terminal 21 (step S703). In addition to the IP address of the electronic whiteboard B 12, authentication information such as a password can be input.

In the electronic whiteboard B 12, when receiving the connection request, the communication control unit 223 transmits, as a response thereto, an indication of successful connection including the version information of software in the electronic whiteboard B 12 to the terminal 21 (step S705).

In the terminal 21, receiving the indication of successful connection, the communication control unit 340 extracts the version information of software in the electronic whiteboard B 12 that is included in the indication of successful connection (step S707), and sends the information to the compatibility determining unit 380.

The compatibility determining unit 380 acquires version information of a communication protocol in the electronic whiteboard B 12 from the version information of software in the electronic whiteboard B 12 (step S709). In this example, similarly to Example 3 above, referring to the version-communication protocol correspondence table, version information of the communication protocol in the electronic whiteboard B 12 is acquired.

The compatibility determining unit 380 then determines compatibility between the communication protocol in the electronic whiteboard B 12 and the communication protocol in the communication control unit 340 (step S711). In this example, as the version of the communication protocol in the electronic whiteboard B 12 is 1.0, and the version of the communication protocol in the communication control unit 340 is 2.0, it is determined as “incompatible”.

The terminal 21 displays an error dialogue (refer to FIG. 14) on the display 370 through the GUI unit 310 (step S713). In addition to a message that connection cannot be established, a message indicating whether a version of software in the terminal is old, or a version of software in the electronic whiteboard is old can be displayed.

The terminal 21 transmits a disconnection request to the electronic whiteboard B 12 through the communication control unit 340 (step S715).

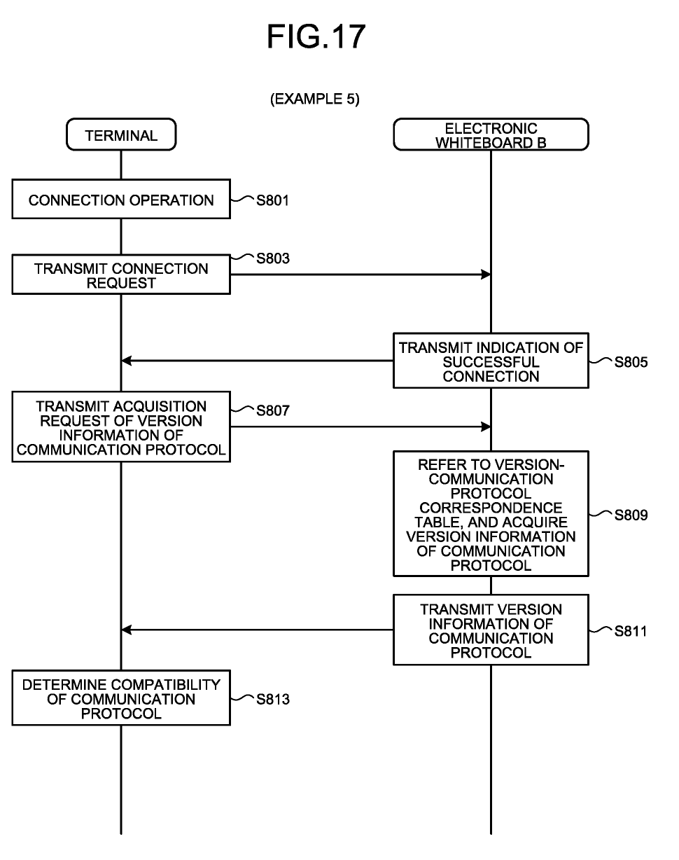

Although version information of a communication protocol in the electronic whiteboard B 12 is acquired from version information of software in the electronic whiteboard B 12 by referring to the version-communication protocol correspondence table in Example 3 and Example 4 described above, it is not limited thereto. For example, version information of a communication protocol in the electronic whiteboard B 12 can be received from the electronic whiteboard B 12. One example of this case is explained as Example 5 using FIG. 17.

When a user of the terminal 21 inputs an IP address of the electronic whiteboard B 12 in the login screen, and presses a “connect” button (step S801), the communication control unit 340 transmits a connection request including version information of software in the terminal 21 (step S803). In addition to the IP address of the electronic whiteboard B 12, authentication information such as a password can be input.

In the electronic whiteboard B 12, when receiving the connection request, the communication control unit 223 transmits, as a response thereto, an indication of successful connection including the version information of software in the electronic whiteboard B 12 to the terminal 21 (step S805).

In the terminal 21, when receiving the indication of successful connection, the communication control unit 340 transmits an acquisition request of the version information of a communication protocol in the electronic whiteboard B 12 to the electronic whiteboard B 12 (step S807).

In the electronic whiteboard B 12, receiving the acquisition request of the version information of the communication protocol, the communication control unit 223 refers to the version-communication protocol correspondence table to acquire the version information of the communication protocol in the communication control unit 223 (step S809).

The electronic whiteboard B 12 transmits the acquired version information of the communication protocol to the terminal 21 (step S811).

In the terminal 21, when receiving the version information of the communication protocol from the electronic whiteboard B 12, the communication control unit 340 sends the information to the compatibility determining unit 380.

The compatibility determining unit 380 determines compatibility between the communication protocol in the electronic whiteboard B 12 and the communication protocol in the communication control unit 340 (step S813).

The terminal 21 then performs processing similar to that of Example 3 or Example 4 according to the determination result obtained by the compatibility determining unit 380.

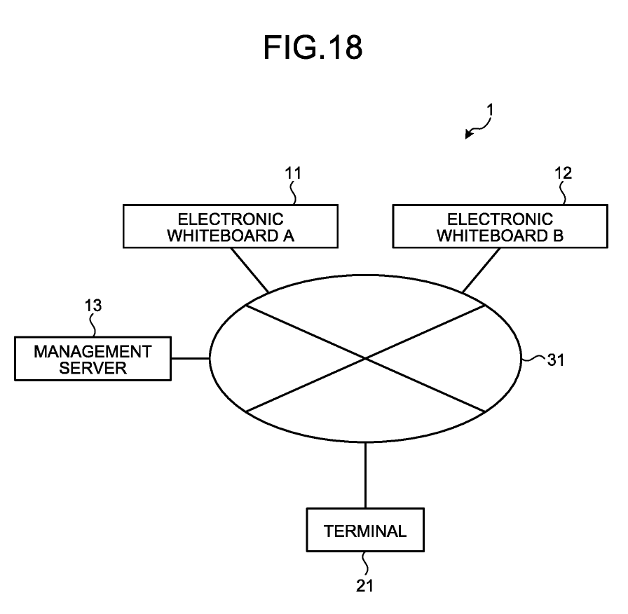

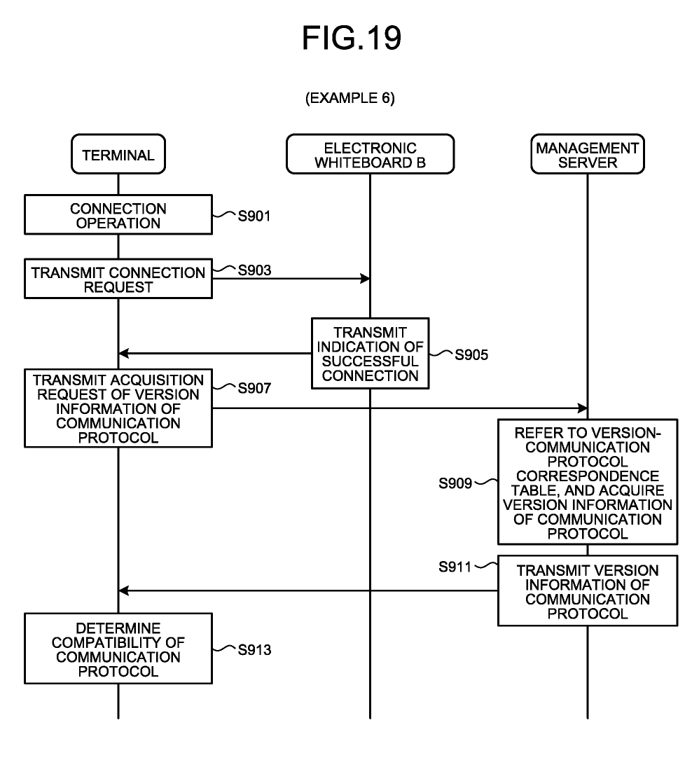

Although a case in which the electronic whiteboard B 12 has the version-communication protocol correspondence table has been explained in Example 5 above, it is not limited thereto. For example, as shown in FIG. 18, when the information system 1 includes the management server 13 connected to the network 31, the management server 13 can have the version-communication protocol correspondence table. One example of this case is explained as Example 6 using FIG. 19.

When a user of the terminal 21 inputs an IP address of the electronic whiteboard B 12 in the login screen, and presses a “connect” button (step S901), the communication control unit 340 transmits a connection request including version information of software in the terminal 21 (step S903). In addition to the IP address of the electronic whiteboard B 12, authentication information such as a password can be input.

In the electronic whiteboard B 12, when receiving the connection request, the communication control unit 223 transmits, as a response thereto, an indication of successful connection including the version information of software in the electronic whiteboard B 12 to the terminal 21 (step S905).

In the terminal 21, when receiving the indication of successful connection, the communication control unit 340 transmits an acquisition request of the version information of a communication protocol in the electronic whiteboard B 12 to the management server 13 (step S907). This request includes the version information of the software in the electronic whiteboard B 12.

Receiving the acquisition request of the version information of the communication protocol, the management server 13 refers to the version-communication protocol correspondence table, and acquires the version information of the communication protocol in the electronic whiteboard B 12 (step S909).

The management server 13 transmits the acquired version information of the communication protocol to the terminal 21 (step S911).

In the terminal 21, when receiving the version information of the communication protocol from the management server 13, the communication control unit 340 sends the information to the compatibility determining unit 380.

The compatibility determining unit 380 determines compatibility between the communication protocol in the electronic whiteboard B 12 and the communication protocol in the communication control unit 340 (step S913).

The terminal 21 then performs processing similar to that of Example 3 or Example 4 according to the determination result obtained by the compatibility determining unit 380.

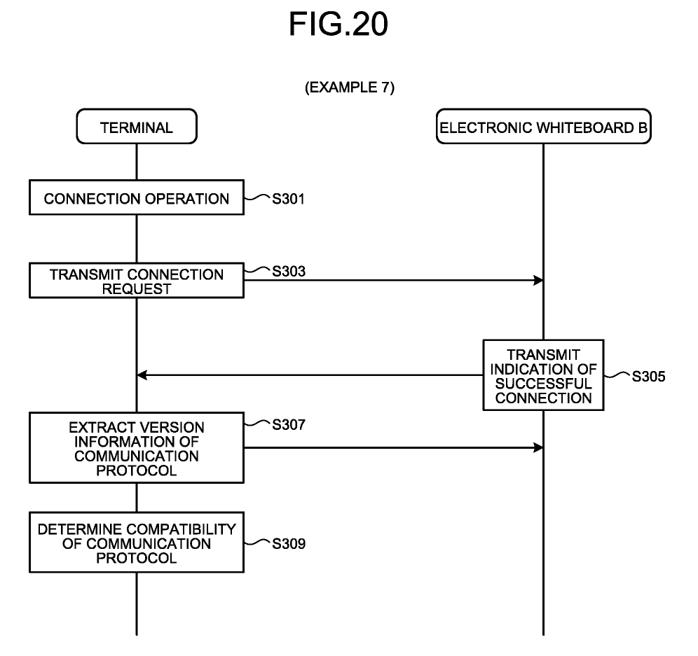

When the response of the electronic whiteboard B 12 to the connection request from the terminal 21 includes version information of a communication protocol in the electronic whiteboard B 12 (for example, the body of an HTTP request (JSON format) {“protocol_ver”:“1.0”, “type”:“request”, “data”:“xxx”, . . . }), the processing of acquiring version information of a communication protocol from version information of software described above is not necessary. One example of this case is explained using FIG. 20.

When a user of the terminal 21 inputs an IP address of the electronic whiteboard B 12 in the login screen, and presses a “connect” button (step S301), the communication control unit 340 transmits a connection request including version information of software in the terminal 21 (step S303). In addition to the IP address of the electronic whiteboard B 12, authentication information such as a password can be input.

In the electronic whiteboard B 12, when receiving the connection request, the communication control unit 223 transmits, as a response thereto, an indication of successful connection including the version information of a communication protocol in the electronic whiteboard B 12 to the terminal 21 (step S305).

In the terminal 21, when receiving the indication of successful connection, the communication control unit 340 extracts the version information of the communication protocol in the electronic whiteboard B 12 that is included in the indication of successful connection (step S307), and sends the information to the compatibility determining unit 380.

The compatibility determining unit 380 determines compatibility between the communication protocol in the electronic whiteboard B 12 and the communication protocol in the communication control unit 340 (step S309).

The terminal 21 then performs processing similar to that of Example 3 or Example 4 according to the determination result obtained by the compatibility determining unit 380.

As is obvious from the above explanation, in the present embodiment, the electronic whiteboard A 11 and the electronic whiteboard B 12 constitute servers in the information system of the present invention, and the terminal 21 constitutes a client in the information system of the present invention. Furthermore, the compatibility determining unit 380 constitutes a first determining unit in the information system of the present invention, and the compatibility determining unit 250 constitutes a second determining unit in the information system of the present invention. Moreover, the ROM 302 constitutes a recording medium of the present invention.

In Example 1 to Example 4, the program of the present invention is executed.

As explained above, the information system 1 according to the present embodiment includes the electronic whiteboard A 11, the electronic whiteboard B 12, the terminal 21, the network 31, and the like.

The terminal 21 has the GUI unit 310, the communication-information managing unit 320, the overall control unit 330, the communication control unit 340, the reproduction control unit 350, the video decoder unit 360, the display 370, the compatibility determining unit 380, and the like as the functions.

When receiving an indication of successful connection as a response from the electronic whiteboard B 12 to a connection request to the electronic whiteboard B 12, the communication control unit 340 extracts version information of software in the electronic whiteboard B 12 included in the response, and sends the information to the compatibility determining unit 380.

The compatibility determining unit 380 acquires version information of a communication protocol in the electronic whiteboard B 12 from the version information of the software in the electronic whiteboard B 12. The compatibility determining unit 380 then determines whether the communication protocols of the electronic whiteboard B 12 and the terminal 21 are compatible with each other from the version information of the communication protocol in the electronic whiteboard B 12.

When the compatibility determining unit 380 determines as compatible, the GUI unit 310 displays a distribution image from the electronic whiteboard B 12 on the display 370.

On the other hand, when the compatibility determining unit 380 determines as incompatible, the communication control unit 340 transmits a disconnection request to the electronic whiteboard B 12, and the GUI unit 310 displays an error dialogue on the display 370.

In the electronic whiteboard A 11, receiving the connection request from the terminal 21, the communication control unit 223 extracts version information of software in the terminal 21 included in the connection request, and sends the information to the compatibility determining unit 250.

The compatibility determining unit 250 acquires version information of a communication protocol in the terminal 21 from the version information of the software in the terminal 21. The compatibility determining unit 250 then determines whether the electronic whiteboard A 11 and the terminal 21 are compatible with each other in communication. The communication control unit 223 transmits a determination result to the terminal 21.

In the terminal 21, when the determination result received from the electronic whiteboard A 11 is compatible, the GUI unit 310 displays a distribution image from the electronic whiteboard A 11 on the display 370. On the other hand, when the determination result received from the electronic whiteboard A 11 is incompatible, the GUI unit 310 displays an error dialogue on the display 370.

Although a case in which the information system 1 includes two electronic whiteboards has been explained in the above embodiment, it is not limited thereto. For example, the information system 1 can include either one of the electronic whiteboard A 11 and the electronic whiteboard B 12, or can include three or more electronic whiteboards.

Furthermore, although a case in which the information system 1 includes a single terminal has been explained in the above embodiment, it is not limited thereto, but the information system 1 can include more than one terminal.

According to the present invention, it is possible to know certainly whether communication protocols are compatible with each other between a server and a client.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

Further, any of the above-described apparatus, devices or units can be implemented as a hardware apparatus, such as a special-purpose circuit or device, or as a hardware/software combination, such as a processor executing a software program.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor. A processing circuit also includes devices such as an application specific integrated circuit (ASIC) and conventional circuit components arranged to perform the recited functions.

The processing circuitry is implemented as at least a portion of a microprocessor. The processing circuitry may be implemented using one or more circuits, one or more microprocessors, microcontrollers, application specific integrated circuits, dedicated hardware, digital signal processors, microcomputers, central processing units, field programmable gate arrays, programmable logic devices, state machines, super computers, or any combination thereof. Also, the processing circuitry may include one or more software modules executable within one or more processing circuits. The processing circuitry may further include memory configured to store instructions and/or code that causes the processing circuitry to execute functions.

If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 101 in a computer system or other system. The machine code may be converted from the source code, etc. If embodied in hardware, each block may represent a circuit or a number of interconnected circuits to implement the specified logical function(s).

What is claimed is:

1. An information system comprising:
a server; and
a client that is connected to the server, wherein
the server transmits, when receiving a connection request from the client, a response that includes any one of version information of software in the server and version information of a communication protocol in the server, to the client, and
the client determines whether a communication protocol in the client is compatible with the server based on the response from the server.

2. The information system according to claim 1, wherein
the client determines whether the communication protocol is compatible with the server based on version information of the communication protocol in the client and the version information of the communication protocol in the server.

3. The information system according to claim 1, wherein
the response from the server includes the version information of software in the server, and
the client acquires the version information of the communication protocol in the server from the version information of software in the server.

4. The information system according to claim 3, wherein
the client has a correspondence table in which version information of software and version information of a communication protocol are associated with each other, and refers to the correspondence table to acquire the version information of the communication protocol in the server from the version information of software in the server.

5. The information system according to claim 1, wherein
the response from the server includes the version information of software in the server,
the client transmits, to the server, an acquisition request of the version information of the communication protocol in the server, and
the server has a correspondence table in which version information of software and version information of a communication protocol are associated with each other, and refers to the correspondence table when receiving the acquisition request, to acquire the version information of the communication protocol in the server from the version information of software in the server, and transmits the acquired version information to the client.

6. The information system according to claim 1, further comprising
a management server that has a correspondence table in which version information of software and version information of a communication protocol are associated with each other, wherein
the client transmits an acquisition request of the version information of the communication protocol in the server, the acquisition request including the version information of software in the server, and
the management server refers to the correspondence table when receiving the acquisition request, to acquire the version information of the communication protocol in the server from the version information of software in the server, to transmit the acquired version information to the client.

7. The information system according to claim 1, wherein
when a result of the determination indicates as incompatible, the client outputs a disconnection request of communication to the server.

8. The information system according to claim 1, wherein the client includes
a display unit; and
a processing unit that displays, when a result of the determination indicates as incompatible, that fact on the display unit.

9. The information system according to claim 1, comprising
a network to which the server and the client are connected.
